(19) United States
(12) Patent Application Publication
(10) Pub. No.: US 2014/0254818 A1
(43) Pub. Date: Sep. 11, 2014

(54) SYSTEM AND METHOD FOR AUTOMATICALLY SWITCHING OPERATIONAL MODES IN A BLUETOOTH EARPHONE

(71) Applicants: Kin-Man TSE, Hong Kong (HK); Wai-Pun Chung, Hong Kong (HK)

(72) Inventors: Kin-Man TSE, Hong Kong (HK); Wai-Pun Chung, Hong Kong (HK)

(73) Assignee: Plastoform Industries Limited, Hong Kong (HK)

(21) Appl. No.: 13/788,244

(22) Filed: Mar. 7, 2013

(51) Int. Cl. H04R 1/10

(52) U.S. Cl. CPC H04R 1/1091
USPC 381/74

(57) ABSTRACT

Disclosed is a system and method for automatically switching operational modes in a Bluetooth earphone. The system includes a first sensor, and a second sensor disposed within left speaker and right speaker of the earphone to detect an earphone in-use situation, and an earphone unused situation, a built-in Bluetooth chip electronically configured in the body of the earphone to receive an earphone in-use signal, and an earphone unused signal from the first sensor, and the second sensor, and an electrical switching circuit in communication with the Bluetooth chip to enable smooth transition of the earphone between a first operational mode, and a second operational mode, wherein, in the first operational mode, the earphone transmits and receives wireless Bluetooth signals to and from an external Bluetooth enabled communication device and plays audio signals, and in the second operational mode, the earphone plays no audio signals until the first sensor and the second sensor further detects the earphone in-use situation.

### FIELD OF THE INVENTION

This invention in general relates to wireless communication system, and more particularly to a Bluetooth earphones configured to automatically switch its operational modes in between a standby mode and a wakeup mode.

### BACKGROUND OF THE INVENTION

Wireless earphones/headsets have become increasingly popular in recent years as they allow the users to keep hands free and move about while they remain in communication with the mobile phones or some other communication devices. Bluetooth is a low-cost, low-power and short-distance wireless communication technology extensively used in all kinds of mobile communication devices including Bluetooth earphones, portable mobile phone watches, and various other types of communication devices.

Bluetooth earphones cooperate with a mobile phone to facilitate the advantages of hands-free functions and avoid limitation in the length of a transmission cables. Hence, Bluetooth earphones have been widely used.

Typically, a user uses Bluetooth wireless earphones/headsets as an accessory with electronic devices, such as mobile phones. By using such wireless headset, the user can use the mobile phone without having to hold it in his hand. In such instances before using the Bluetooth earphone, the user has to manually perform some process to activate or deactivate the Bluetooth earphone. This process is complex and time consuming.

In the light of foregoing, what is needed is a Bluetooth enabled earphones capable of automatically switching between a wake-up mode and a standby mode when the Bluetooth earphones are in in-use, and unused situations respectively.

### BRIEF SUMMARY OF THE INVENTION

One object of this invention is to provide a Bluetooth earphone that automatically changes its operational modes, from a wake-up mode or an on mode to a standby or a stop mode or vice versa.

Another object of this invention is to provide the Bluetooth earphone that helps access an additional functionality of the hands-free technology offered by Bluetooth protocol, and that would overcome or at least ameliorates the short comings associated with conventional usage of the Bluetooth enabled earphones.

In accordance with an aspect of this invention, a system for automatically switching operational modes in a Bluetooth earphone includes a first sensor, and a second sensor disposed within left side speaker and right side speaker of the earphone to detect at least one an earphone in-use situation, and an earphone unused situation, a built-in Bluetooth chip electronically configured in the body of the earphone to receive an earphone in-use signal, and an earphone unused signal from the first sensor, and the second sensor, and an electrical switching circuit in communication with the built-in Bluetooth chip to enable smooth transition of the earphone between a first operational mode, and a second operational mode, wherein, in said first operational mode, the earphone transmits and receives wireless Bluetooth signals to and from an external Bluetooth enabled communication device to play audio signals via the left side speaker and the right side speaker, and in said second operational mode, the earphone play no audio signals until the first sensor and the second sensor further detects the earphone in-use situation and activates the Bluetooth chip to enter into the first operational mode.

In accordance with another aspect of this invention, a method for automatically switching operational modes in a Bluetooth earphone includes detection of at least one an earphone in-use situation, and an earphone unused situation, by a first sensor, and a second sensor disposed within left side speaker and right side speaker of the earphone, reception of an earphone in-use signal, and an earphone unused signal from the first sensor, and the second sensor, by a built-in Bluetooth chip electronically configured in the body of the earphone, and transition of the earphone between a first operational mode, and a second operational mode, by means of an electrical switching circuit configured to communication with the built-in Bluetooth chip, wherein, in said first operational mode, the earphone is characterized to transmit and receive a plurality of wireless Bluetooth signals to and from an external Bluetooth enabled communication device to play audio signals via the left side speaker and the right side speaker, and in the second operational mode, the earphone is characterized to play no audio signals until the first sensor and the second sensor further detects the earphone in-use situation and activates the Bluetooth chip to enter into the first operational mode.

These and other objectives, aspects, of the present subject matter will be better understood with reference to the following description. This summary is just provided to introduce the concept in a simplified form. The summary is not intended to identify key features or essential features of the proposed subject matter, nor is it intended to be used to limit the scope of the proposed subject matter.

### BRIEF DESCRIPTION OF DRAWINGS

Various objects, features and advantages of the present invention will become fully appreciated as the same becomes better understood when considered in conjunction with the accompanying drawings reflecting illustrative embodiments of the invention, wherein:

FIG. 1A is a diagram illustrating an earphone in-use situation in which a Bluetooth earphone is held near the user's ears, according to an exemplary embodiment;

FIG. 1B is diagrams illustrating an earphone unused situation in which the Bluetooth earphone is held away from the user's ears, according to an exemplary embodiment;

FIG. 2 is a conceptual block diagram illustrating an example of the functionality of the Bluetooth earphone, according to an embodiment of this invention;

FIG. 3 is a flowchart illustrating an overall method for automatically switching operational modes in the Bluetooth earphone, according to an example embodiment; and

FIG. 4A-FIG. 4B are flowcharts illustrating example methods for automatically switching the Bluetooth earphone in between a wakeup mode, and a standby mode respectively, according to an embodiment of this invention;

### DETAILED DESCRIPTION OF THE PREFERRED EMBODIMENTS

Before explaining at least one embodiment of the present invention in detail, it is to be understood that the invention is not limited in its application to the details of construction set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, while the embodiments are described as containing terms “first”, “second”, and the like, herein do not denote any order, quantity, or importance, but rather are used to distinguish one element from another.

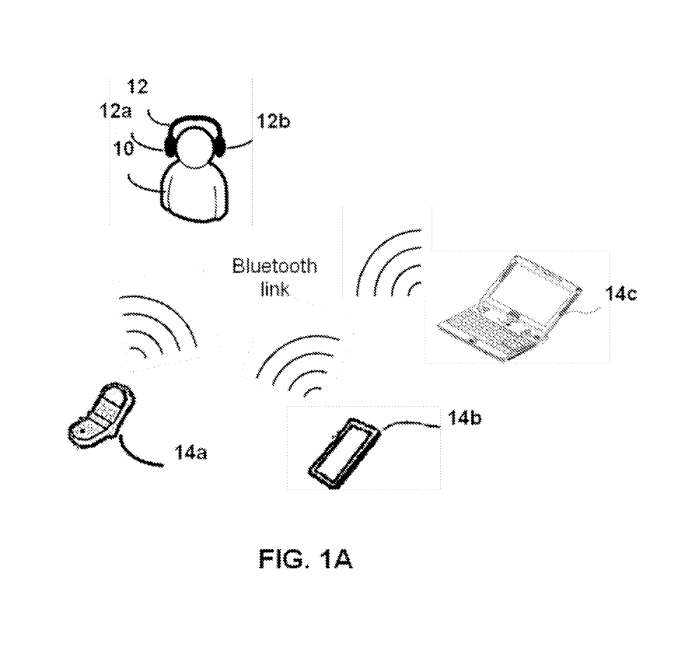

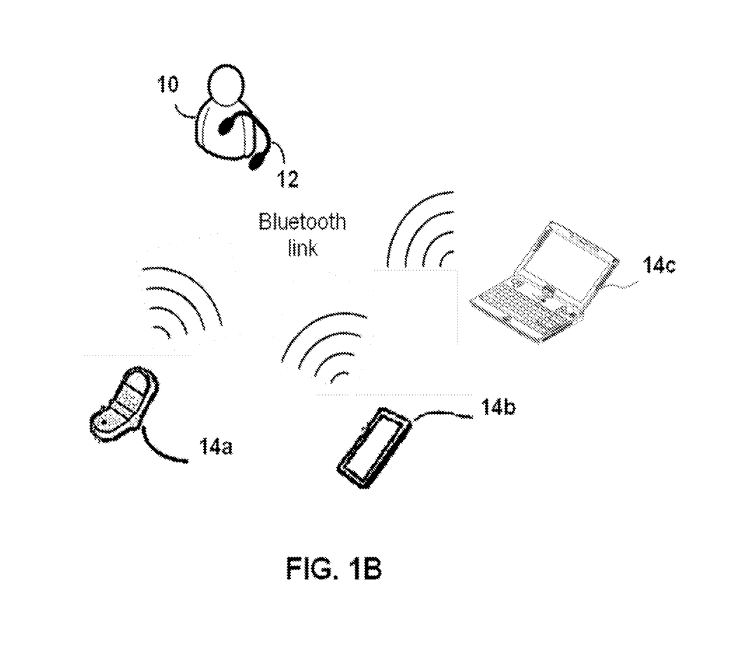

The illustrative embodiments of the present invention are directed towards a system and method for automatically switching operational modes in a Bluetooth earphone. Turning now to the accompanying drawings, FIG. 1A-FIG. 1B illustrates an earphone in-use situation in which the Bluetooth earphone 12 is held near the user's 10 ears and/or is worn by the user 10, and an earphone unused situation in which the Bluetooth earphone 12 is held away from the user's 10 ears respectively.

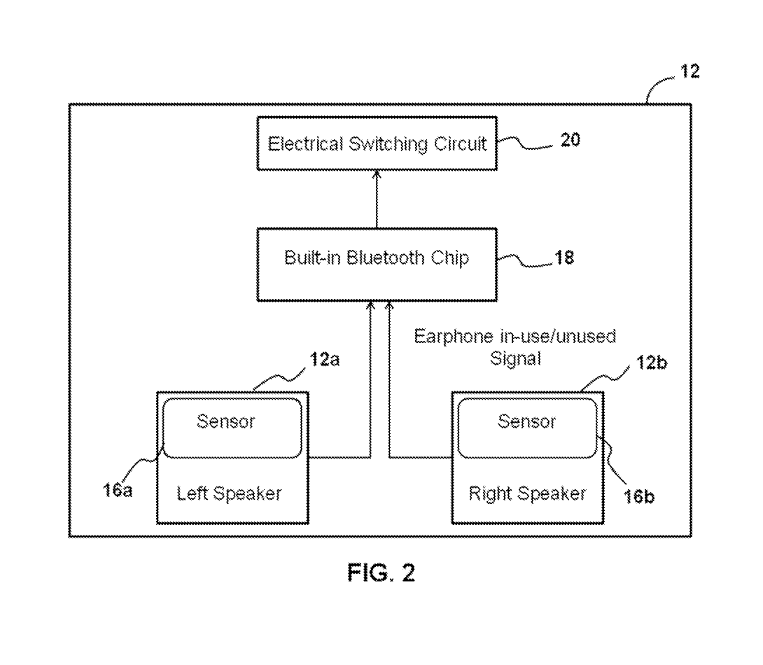

Referring to FIG. 2, which illustrates an example of the functionality of a Bluetooth earphone 12 including a first sensor 16a, and a second sensor 16b embodied inside a left speaker 12a and a right speaker 12a of the earphone 12, a built-in Bluetooth chip 18 electronically configured in the body of the earphone 12 and in communication with the sensors 16a, 16b, and an electrical switching circuit 20 configured to communicate with the built-in Bluetooth chip 18 such as to enable smooth transition of the Bluetooth earphone 12 in between a first operational mode i.e. a wakeup mode or an active mode, and a second operational mode i.e. a standby mode or a stop mode.

Turning now to details of the functionality, in the in-use situation, the sensors 16a, 16b of the earphone 12 comes in contact or in the proximity of the left ear and right ear of the user 10, as shown in FIG. 1A. The sensors 16a, 16b are preferably, but not limited to pressure sensors conventionally available in the market. The sensors 16a, 16b detect the earphone in-use situation and then transmit one or more earphone in-use signals (as shown in FIG. 2) to the built-in Bluetooth chip 18 present in the body of the earphone 12. The Bluetooth chip 18 on receiving the earphone in-use signal from the sensors 16a, 16b switches to the wakeup or the on mode via the electrical switching circuit 20 communicatively coupled with the chip 18. The Bluetooth Chip 18 in the wakeup mode enables smooth Bluetooth operation in the earphone 12 and enables the earphone 12 to play audio signals via the left speaker 12a, and the right speaker 12b.

According to this embodiment, when the user 10 of the earphone 12 establishes a Bluetooth connectivity with an external Bluetooth enabled communication device a mobile phone 14a, a tablet 14b, or a laptop 14b, or a personal digital assistant (PDA) and the like, the earphone 12 receives wireless Bluetooth signals relayed from the external Bluetooth enabled communication devices preferably by means of a transceiver module (not shown) configured thereon. As will be apparent to those skilled in the art, the transceiver module is also capable of transmitting wireless Bluetooth signals away from the earphone 12 to the Bluetooth enabled communication devices 14a, 14b, and 14c. By the way of an example, the audio being played by the Bluetooth enabled communication device say the mobile phone 14a is continuously shared with the Bluetooth earphone 12 and played via the speakers 12a, 12b provided thereof as long as the earphone 12 is in the in-use situation and the Bluetooth chip 18 remain in the wakeup mode.

Turning next to the details of the functionality, in the earphone unused situation, as is shown in FIG. 1B, where the Bluetooth earphone 12 is held away from the user's 10 ears, the sensors 16a, 16b detects the earphone unused situation and then transmit one or more earphone unused signals (as shown in FIG. 2) to the built-in Bluetooth chip 18. The Bluetooth chip 18 upon receiving the earphone unused signal from the sensors 16a, 16b switches to a standby or a stop mode of operation via the electrical switching circuit 20. The Bluetooth chip 18 on entering the standby mode pause audio signals from being played via the left side speaker 12a, and the right side speaker 12b until the sensors 16a, 16b again detects the earphone in-used situation and activates the Bluetooth chip 18 to re-enter in the wakeup mode.

In this embodiment, when the user 10 of the earphone 12 establishes a Bluetooth connectivity with the external Bluetooth enabled communication device a mobile phone 14a, a tablet 14b, or a laptop 14b, and the like, the earphone 12 receives wireless Bluetooth signals relayed from the Bluetooth enabled communication devices 14a, 14b, and 14c by means of a transceiver module. But since the Bluetooth chip 18 remains in the inactive or the standby mode, the audio being played by the Bluetooth enabled communication device say the mobile phone 14a is restricted to get played via the speakers 12a, and 12b causing temporary pause until resumed, when the sensors 16a, 16b detect the earphone in-use situations again and the chip 18 is switched to operate in the wakeup mode.

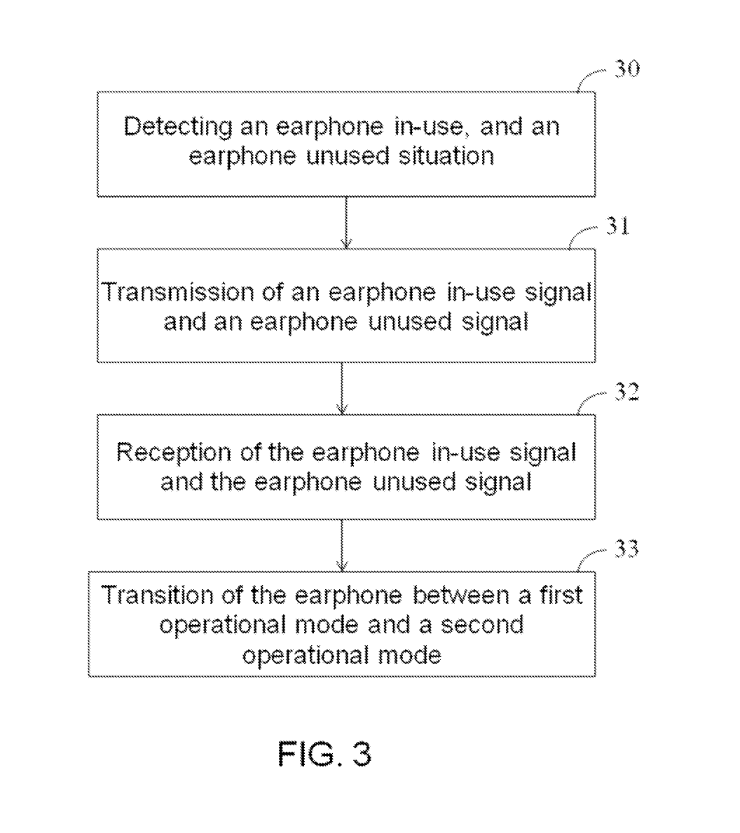

Referring to FIG. 3 is a flow diagram, which illustrates an overall methodology for automatically switching operational modes in a Bluetooth earphone, in accordance with the present invention. As shown in FIG. 3, the flow starts at step 30 which describes detection of an earphone in-use and unused situation by sensors preferably embodied inside a left speaker and a right speaker present in the earphone. The sensors preferably include readily available pressure sensors. Flow then proceeds to step 31.

The step 31 describes about transmission of an earphone in-use signal or an earphone unused signal on detecting the earphone in-use situation, or the earphone unused situation respectively by the sensors to an in-built Bluetooth chip configured on the body of the earphone. Flow then proceeds to step 32 which describes about reception of the earphone in-use signal or the earphone unused signal by the Bluetooth chip communicatively linked with an electrical switching circuit. Flow then proceeds to step 33.

The step 33 described about transition of the Bluetooth chip from a first operational mode to a second operational mode and vice versa. The Bluetooth chip enters into the first operational mode or a wakeup mode on detecting the earphone in-use signal from the sensors. Similarly, the Bluetooth chip enters into the second operational mode or standby mode on detecting the earphone unused signal from the sensors.

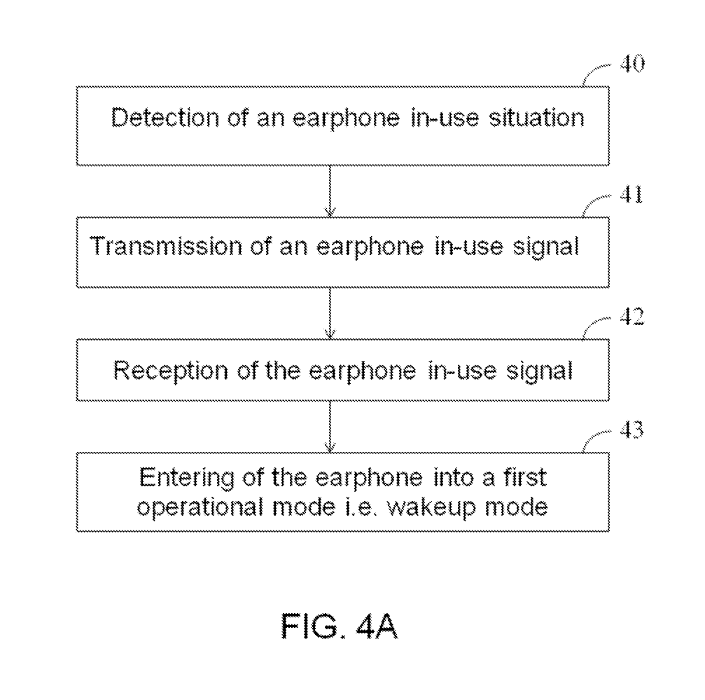

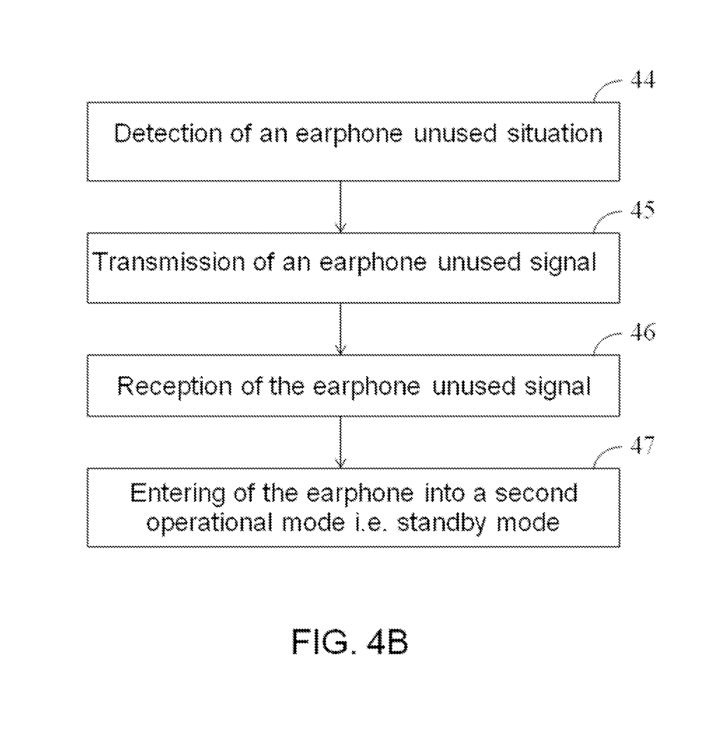

Turning now to FIG. 4A-FIG. 4B, illustrates example methods for automatically switching a Bluetooth earphone in between a wakeup mode, and a standby mode, according to an embodiment. As shown in FIG. 4A, the method starts with detection of an earphone in-use situation (step 40) by the sensors preferably embodied in the speakers of the earphone. In the earphone in use situation, the earphone is held close to the ears of the user. On detecting the earphone in-use situation, the sensors transmit an earphone in-use signal to a Bluetooth chip in-built and present in the body of the earphone (step 41). On receiving the earphone in-use signal (step 42), the chip enters into a wakeup mode or an active/on mode (step 43). In the wakeup mode, the earphone is capable of establishing a Bluetooth connectivity with an external Bluetooth enabled communication device a mobile phone, a tablet, or a laptop, and the like and capable of playing audio signals via speakers of the earphone.

Further as shown in FIG. 4B, the method starts with detection of an earphone unused situation (step 44) by the sensors. In the earphone unused situation, the earphone is held away from the ears of the user. On detecting the earphone unused situation, the sensors transmit an earphone unused signal to the Bluetooth chip (step 45). On receiving the earphone unused signal (step 46), the chip enters into a standby mode or a stop mode (step 47). In the standby mode, the earphone though may be capable of establishing Bluetooth connectivity with the external Bluetooth enabled communication device like mobile phone but would not be able to play the audio signals via the speakers as long as the Bluetooth chip remains in the inactive or the standby mode. Further, when the earphone is worn or brought near to the ears, the sensors detects the earphone in-use situation again and the Bluetooth chip reenters into the wakeup mode resuming the paused audio signals from pause condition.

Although the present invention has been described with reference to specific embodiments thereof, these embodiments are merely illustrative, and not restrictive, of the present invention. Various modifications or changes to the disclosed example embodiments will be suggested to person skilled in the art. For example, while embodiments have been described in the context of Bluetooth wireless transmission for the Bluetooth earphones, the system and method disclosed herein are applicable to any other application in which change in the operational modes is desirable.

Further, while various example embodiments herein are described considering those skilled in the art will readily appreciate and understand the general concept of wireless/Bluetooth transmission applied in between wireless Bluetooth earphone and external wireless enabled communication devices. Further, the various disclosed embodiments are described as transmitting and receiving Bluetooth signals, the employed transceiver may alternatively be configured to transmit and receive according to other types of wireless techniques without limiting the scope of this invention.

What is claimed is:

1. A system for automatically switching operational modes in a Bluetooth earphone, comprising:
a first sensor, and a second sensor disposed within left speaker and right speaker of said earphone to detect at least one an earphone in-use situation, and an earphone unused situation;
a built-in Bluetooth chip electronically configured in the body of said earphone to receive an earphone in-use signal, and an earphone unused signal from said first sensor, and said second sensor; and
an electrical switching circuit in communication with said built-in Bluetooth chip to enable smooth transition of said earphone between a first operational mode, and a second operational mode, wherein, in said first operational mode, said earphone transmits and receives a plurality of wireless Bluetooth signals to and from an external Bluetooth enabled communication device and plays audio signals via said left speaker and right speaker, and in said second operational mode, said earphone plays no audio signals.

2. The system of claim 1 further comprising a transceiver module to enable said earphone to receive said plurality of wireless Bluetooth signals.

3. The system of claim 1, wherein said first operational mode being a wakeup mode existing during said earphone in-use situation.

4. The system of claim 1, wherein said second operational mode being a standby mode existing during said earphone unused situation.

5. The system claim 1, wherein said external Bluetooth enabled communication device forming a communication pair with said Bluetooth earphone comprises at least one mobile phone, a computer, and a personal digital assistant.

6. The system of claim 1, wherein said earphone in-use signal received by said built-in Bluetooth chip enables said earphone to enter said first operational mode.

7. The system of claim 1, wherein said earphone unused signal received by said built-in Bluetooth chip enables said earphone to enter said second operational mode.

8. A method for automatically switching operational modes in a Bluetooth earphone, said method comprising steps of:
detecting, at least one an earphone in-use situation, and an earphone unused situation, by a first sensor, and a second sensor disposed within left speaker and right speaker of said earphone;
receiving, an earphone in-use signal, and an earphone unused signal from said first sensor, and said second sensor, by a built-in Bluetooth chip electronically configured in the body of said earphone; and
enabling, transition of said earphone between a first operational mode, and a second operational mode, by an electrical switching circuit in communication with said built-in Bluetooth chip, wherein, in said first operational mode, said earphone is characterized to transmit and receive a plurality of wireless Bluetooth signals to and from an external Bluetooth enabled communication device and plays audio signals via said left speaker and right speaker, and in said second operational mode, said earphone plays no audio signals.

9. The method of claim 8, wherein said reception of said earphone in-use signal by said built-in Bluetooth chip enables said earphone to enter said first operational mode.

10. The method of claim 9, wherein said first operational mode being a wakeup mode existing during said earphone in-use situation.

11. The method of claim 8, wherein said reception of said earphone unused signal by said built-in Bluetooth chip enables said earphone to enter said second operational mode.

12. The method of claim 11, wherein said second operational mode being a standby mode existing during said earphone unused situation.
